(19) United States
(12) Patent Application Publication
(10) Pub. No.: US 2016/0338074 A1
(43) Pub. Date: Nov. 17, 2016

(54) Method and Apparatus of Latency Measurement for LTE-WLAN Aggregation

(71) Applicant: MEDIATEK INC., Hsinchu (TW)

(72) Inventors: Chie-Ming Chou, Taichung City (TW); Chia-Chun Hsu, New taipei City (TW); Pavan Santhana Krishna Nuggehalli, San Carlos, CA (US)

(21) Appl. No.: 15/153,990

(22) Filed: May 13, 2016

Related U.S. Application Data
(60) Provisional application No. 62/162,265, filed on May 15, 2015.

(51) Int. Cl. H04W 72/08; H04W 76/04

(52) U.S. Cl. CPC H04W 72/085; H04W 76/046

(57) ABSTRACT

LWA (LTE-WLAN Aggregation) is a tight integration at radio level which allows for real-time channel and load aware radio resource management across WLAN and LTE to provide significant capacity and quality of experience (QoE) improvements. When enabling LWA, packets are routed to a base station (eNB) for performing PDCP functionalities as an LTE PDU. Afterwards, the eNB can schedule the PDU either translated over LTE link or WLAN link. The eNB can acquire packet delay information regarding the WLAN link or obtain PDCP layer performance feedback from the UE. As a result, the eNB can adjust PDCP parameter setting and LWA scheduling accordingly.

### CROSS REFERENCE TO RELATED APPLICATIONS

This application claims priority under 35 U.S.C. §119 from U.S. Provisional Application No. 62/162,265 entitled “Method and Apparatus of Latency Measurement for LTE-WLAN Aggregation” filed on May 15, 2015, the subject matter of which is incorporated herein by reference.

### TECHNICAL FIELD

The disclosed embodiments relate generally to wireless communication, and, more particularly, to latency measurement and reporting for LTE-WLAN aggregation.

### BACKGROUND

Mobile data usage has been increasing at an exponential rate in recent year. A Long-Term Evolution (LTE) system offers high peak data rates, low latency, improved system capacity, and low operating cost resulting from simplified network architecture. In LTE systems, an evolved universal terrestrial radio access network (E-UTRAN) includes a plurality of base stations, such as evolved Node-B's (eNBs) communicating with a plurality of mobile stations referred as user equipment (UEs). However, the continuously rising demand for data traffic requires additional solutions. Interworking between the LTE network and the unlicensed spectrum WLAN provides additional bandwidth to the operators.

The current approaches of interworking of LTE and WLAN suffer from various limitations that hamper the benefits of LTE-WLAN interworking. For example, core network approaches like Access Network Discovery and Selection Function (ANDSF) provide rich support for implementing operator policy, providing subscriber specific service, and enabling different kinds of WLAN deployment (e.g., trusted and non-trusted WLANs). However, the core network approaches suffer from significant performance shortcomings. These approaches are unable to react to dynamically varying radio conditions and do not permit aggregation of IP flows over LTE and WLAN access. Some of these limitations have been addressed 3GPP on RAN assisted 3GPP/WLAN interworking (IWK). While the RAN assisted IWK feature promises to improve Quality of Experience (QoE) and network utilization, it is also limited by the inability to aggregate IP flows as well as support of limited traffic granularity at the PDN level.

A potential solution to more fully reap the benefits of LTE-WLAN interworking is to allow LTE-WLAN aggregation (LWA) by integrating the protocol stacks of LTE and WLAN systems. The LTE-WLAN aggregation (LWA) provides data aggregation at the radio access network where an eNB schedules packets to be served on LTE and Wi-Fi radio link. The advantage of this solution is that LWA can provide better control and utilization of resources on both links. LWA can increase the aggregate throughput for all users and improve the total system capacity by better managing the radio resources among users. LWA borrows the concept of existing dual connectivity (DuCo) to let WLAN network being transport to Core Network (CN) for reducing CN load and support “packet level” offload. Under the architecture, the eNB can schedule the translation of PDU either by LTE or WLAN dynamically to improve UE perceived throughput (UPT). Thus, the scheduler is responsible to decide how many packets (or the traffic dispatching ratio) are translated to LTE/WLAN appropriately.

Under DuCo deployment, with existing CP interface between SeNB, the MeNB is able to identify the shortest and longest packet latency (e.g. cover the backhaul latency, ARQ maximum transmission time, and scheduling latency) to configure the reordering timer value appropriately. Meanwhile, with X2-UP signaling (i.e., DL USER DATA, DL DATA DELIVERY STATUS), the MeNB and SeNB can exchange the successful PDU delivery information and buffer size information to allow the flow control of PDU over the X2 interface. Unfortunately, such CP/UP interface does not exist under LWA and eNB fails to understand the backhaul delay information and WLAN's PDCP PDU delivery status when PDU is translating to WLAN link. Moreover, deciding the traffic dispatching ratio only based on channel condition and AP loading, it is still difficult for eNB to estimate the overall packet delay when the PDU is translating to WLAN link and thus not able to provision the QoS requirement. This is because AP loading only reflects the queuing time AP has, but it does represent the active transmission time accurately. A solution on how to provide delay information of WLAN link and PDCP layer performance feedback to eNB and thereby facilitating LWA PDCP setting/scheduling is sought.

### SUMMARY

LWA (LTE/WLAN Aggregation) is a tight integration at radio level which allows for real-time channel and load aware radio resource management across WLAN and LTE to provide significant capacity and quality of experience (QoE) improvements. When enabling LWA, packets are routed to a base station (eNB) for performing PDCP functionalities as an LTE PDU. Afterwards, the eNB can schedule the PDU either translated over LTE link or WLAN link. The eNB can acquire packet delay information regarding the WLAN link or obtain PDCP layer performance feedback from the UE. As a result, the eNB can adjust PDCP parameter setting and LWA scheduling accordingly.

In one embodiment, a UE receives an LTE WLAN aggregation (LWA) configuration from a base station in a wireless network. The UE is connected to both the base station and an LWA-enabled access point (AP). The UE receives a radio resource control (RRC) signaling message from the base station. The RRC signaling message comprises reporting configuration for packet data convergence protocol (PDCP) status. The UE performs PDCP layer status collection. The UE transmits a PDCP status report to the base station based on the reporting configuration. In one embodiment, the PDCP status comprises PDCP error events. In another embodiment, the PDCP status comprises PDCP PDU statistics.

In another embodiment, a base station configures LTE WLAN aggregation (LWA) for a UE in a wireless network. The UE is connected to both the base station and an LWA-enabled access point (AP). The base station transmits a radio resource control (RRC) signaling message to the UE. The RRC signaling message comprises reporting configuration for PDCP layer status. The base station receives a PDCP status report from the UE. The base station adjusts PDCP parameters and LWA scheduling based on the received PDCP status report. In one embodiment, the PDCP status comprises PDCP error events. In another embodiment, the PDCP status comprises PDCP PDU statistics.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with LTE-WAN aggregation (LWA) in accordance with embodiments of the current invention.

FIG. 2 illustrates simplified block diagram of LWA enabled network entities in accordance with embodiments of the current invention.

FIG. 3 illustrates an example of the composition of a packet delay via WLAN link in a wireless communication network 300.

FIG. 4 illustrates functional blocks of a measurement-based solution of providing packet delay information for LWA.

FIG. 5 illustrates a first example of packet delay measurements using user plane PDCP PDU.

FIG. 6 illustrates a second example of packet delay measurements using user plane PDCP PDU.

FIG. 7 illustrates an example of packet delay measurements using control plane PDCP PDU.

FIG. 8 illustrates functional blocks of an adjustment-based solution of providing PDCP performance information for LWA.

FIG. 9 illustrates one embodiment of PDCP error report for adjusting PDCP parameter setting and LWA scheduling.

FIG. 10 illustrates one embodiment of PDCP PDU statistics report for adjusting PDCP parameter setting and LWA scheduling.

FIG. 11 is a flow chart of a method of providing PDCP status report from UE perspective for adjusting PDCP parameter setting and LWA scheduling in accordance with one novel aspect.

FIG. 12 is a flow chart of a method of providing PDCP status report for adjusting PDCP parameter setting and LWA scheduling from eNB perspective in accordance with one novel aspect.

### DETAILED DESCRIPTION

Reference will now be made in detail to some embodiments of the invention, examples of which are illustrated in the accompanying drawings.

FIG. 1 illustrates a system diagram of a wireless network 100 with LTE-WLAN aggregation (LWA) in accordance with embodiments of the current invention. Wireless network 100 comprises a base station eNB 101 that provides LTE cellular radio access via E-UTRAN, an access point AP 102 that provides Wi-Fi radio access via WLAN, and a user equipment UE 103. LTE-WLAN Aggregation (LWA) is a tight integration at radio level, which allows for real-time channel and load-aware radio resource management across LTE and WLAN to provide significant capacity and Quality of Experience (QoE) improvements. When enabling LWA, S1-U interface is terminated at eNB 101 whereby all IP packets are routed to eNB 101 and performed with PDCP layer operations as an LTE PDU. Afterwards, eNB 101 can schedule whether LWA-LTE link 110 or LWA-Wi-Fi link 120 the LTE PDU shall go. LWA borrows the concept of existing dual connectivity (DuCo) to let WLAN network being transport to the core network (CN) for reducing CN load and support “Packet level” offload.

In the example of FIG. 1, IP packets are carried between a serving gateway and eNB 101 over the S1-U interface. The LWA capable eNB 101 performs legacy PDCP layer operations such as ciphering and header compression (ROHC). In addition, the LWA capable eNB 101 is responsible for aggregating data flows over the LTE and WLAN air-interfaces. For example, the PDCP entity of the LWA capable eNB 101 performs traffic splitting, floor control, and new PDCP header handling for LWA packets received from the serving gateway. In the downlink, eNB 101 can schedule a few PDCP PDUs over LTE access and the remaining over WLAN access. The PDCP entity of the LWA capable UE 103 buffers the PDCP PDUs received over LTE and WLAN air interfaces and performs appropriate functions such as traffic converging and reordering, new PDCP header handling, and legacy PDCP operation. Similar functionality is also required for the uplink.

When eNB 101 schedules the packet to LTE link 110, based on configured SN length, corresponding PDCP header is added as a formal user data structure and then the PDCP PDU is sending to RLC entity. Alternatively, when the eNB 101 schedules the packet to WLAN link 120 to facilitate transmission over Wi-Fi radio, the PDCP entity will encapsulate the packet as an IEEE 802 frame format and consequently ferry the frame to WLAN AP 102 through user plane interface. Under the architecture, the eNB can schedule the translation of PDU either by LTE or WLAN dynamically to improve UE perceived throughput (UPT). Thus, the scheduling is responsible to decide how many packets (or the traffic dispatching ratio) are translated to LTE/WLAN appropriately. The eNB may perform such scheduling based on respective channel conditions or loadings, wherein the different scheduling algorithms may influence UPT a lot. On the other hand, when UE receives the PDU, it shall put it into corresponding PDCP buffer for reordering aspects and then send it to upper layer when the reordering is accomplished. A reordering timer would be configured to detect the loss PDU and flush the buffered PDUs when bearer is splitting. A proper setting of reordering timer not only improves L2 throughput but also utilizes L2 buffer.

In accordance with a novel aspect, to facilitate LWA PDCP setting/scheduling, a method of providing corresponding valid information based on UE feedback is proposed as depict by 130. In a measurement-based approach, eNB 101 will configure a delay measurement and then translates PDUs to UE 103 over WLAN link 120. UE 103 will measure the round-trip delay with regarding to the target PDU and report the measured delay based on reporting configuration. In an adjustment-based approach, instead of acquiring PDU delay directly, eNB 101 may decide the PDCP setting and scheduling based on RSRP measurement and delay estimation (e.g. using AP load to estimate the rough packet delay). When LWA is running, UE 103 is requested to provide PDCP layer performance results and eNB 101 may adjust the scheduling/PDCP setting if needed.

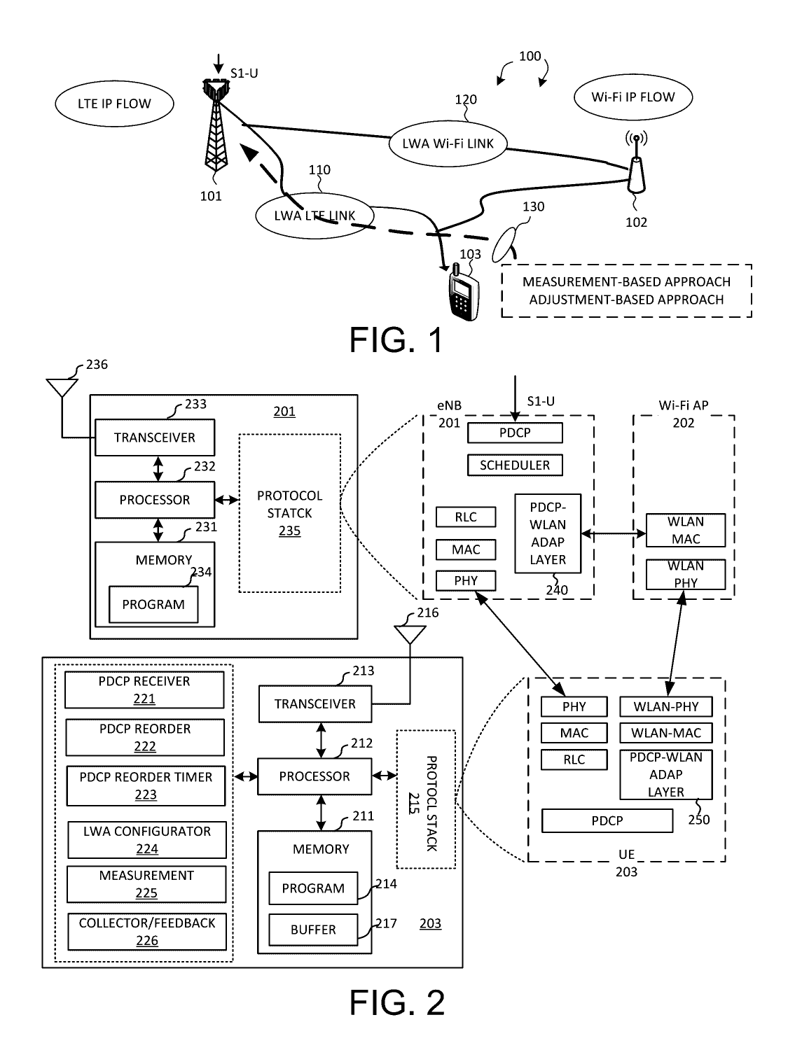

FIG. 2 illustrates simplified block diagrams for eNB 201, Wi-Fi AP 202, and UE 203. UE 203 has radio frequency (RF) transceiver module 213, coupled with antenna 216 receives RF signals from antenna 216, converts them to baseband signals and sends them to processor 212. RF transceiver 213 also converts received baseband signals from the processor 212, converts them to RF signals, and sends out to antenna 216. Processor 212 processes the received baseband signals and invokes different functional modules to perform features in UE 203. Memory 211 stores program instructions and data 214 and buffer 217 to control the operations of UE 203.

UE 203 also includes multiple function modules and circuits that carry out different tasks in accordance with embodiments of the current invention. UE 203 includes a PDCP receiver 221, a PDCP reordering handler 222, a PDCP reordering timer 223, an LWA configuration module 224, a measurement module 225, and a collector/feedback module 226. PDCP receiver 221 receives one or more PDCP protocol data units (PDUs) from lower layers. PDCP reordering module 222 performs a timer-based PDCP reordering process upon detecting a PDCP gap condition. PDCP reordering timer 223 starts a reordering timer when detecting the PDCP gap existing condition and detecting no reordering timer running. LWA configurator 224 configures LWA configuration received from the network form delay measurement and PDCP status report. Measurement module 225 measures delay for target PDU. Collector/Feedback module 226 reports measurement results and collected PDCP status to the serving base station.

Similarly, FIG. 2 shows an exemplary block diagram for eNB 201. eNB 201 has RF transceiver module 233, coupled with antenna 236 receives RF signals from antenna 236, converts them to baseband signals and sends them to processor 232. RF transceiver 233 also converts received baseband signals from the processor 232, converts them to RF signals, and sends out to antenna 236. Processor 232 processes the received baseband signals and invokes different functional modules to perform features in eNB 201. Memory 233 stores program instructions and data 234 to control the operations of eNB 201. A protocol stack 235 performs enhanced protocol stack task in accordance to embodiments of the current invention.

FIG. 2 also shows that UE 203 is LWA-enabled and connects with an eNB 201 and a WLAN AP 202 with data aggregation at radio link level in accordance with embodiments of the current invention. UE 203 is connected with eNB 201. UE 203 also selects WLAN AP 202 for data aggregation. In protocol stack 235, eNB 201 has a PHY layer, a MAC layer, a RLC layer, a scheduler, and a PDCP layer. To enable the LWA, eNB 201 also has a PDCP-WLAN adapter 240 that aggregates the LTE data traffic through PHY with WLAN data traffic through WLAN AP 202. WLAN AP 202 has a WLAN PHY layer and a WLAN MAC layer. WLAN AP 202 connects with the WLAN network and can offload data traffic from the LTE network when UE 203 is connected with both the eNB 201 and the AP 202.

UE 203 is LWA-enabled. UE 203 has a PHY layer, a MAC layer, and a RLC layer that connect with the LTE eNB 201. UE 203 also has a WLAN PHY layer and a WLAN MAC layer that connect with WLAN AP 202. A WLAN-PDCP adaptation layer 250 handles the split bearer from the LTE and the WLAN. UE 203 also has a PDCP layer entity. UE 203 aggregates its data traffic with eNB 201 and AP 202. WLAN PHY of WLAN AP 202 connects with WLAN PHY of UE 203 through a WLAN interface. PHY layer of LTE eNB 201 connects with PHY layer of UE 203 through a uu interface. For LWA, both the LTE data traffic and the WLAN data traffic are aggregated at the PDCP layer of UE 203. The PDCP-WLAN adaptation layer 240 at the eNB and the WLAN-PDCP adaptation layer 250 at the UE are proposed to facilitate transmission of LTE PDCP PDUs using WLAN frames in the downlink. Similar adaptation layers are proposed for uplink transmission of PDCP PDUs using WLAN frames.

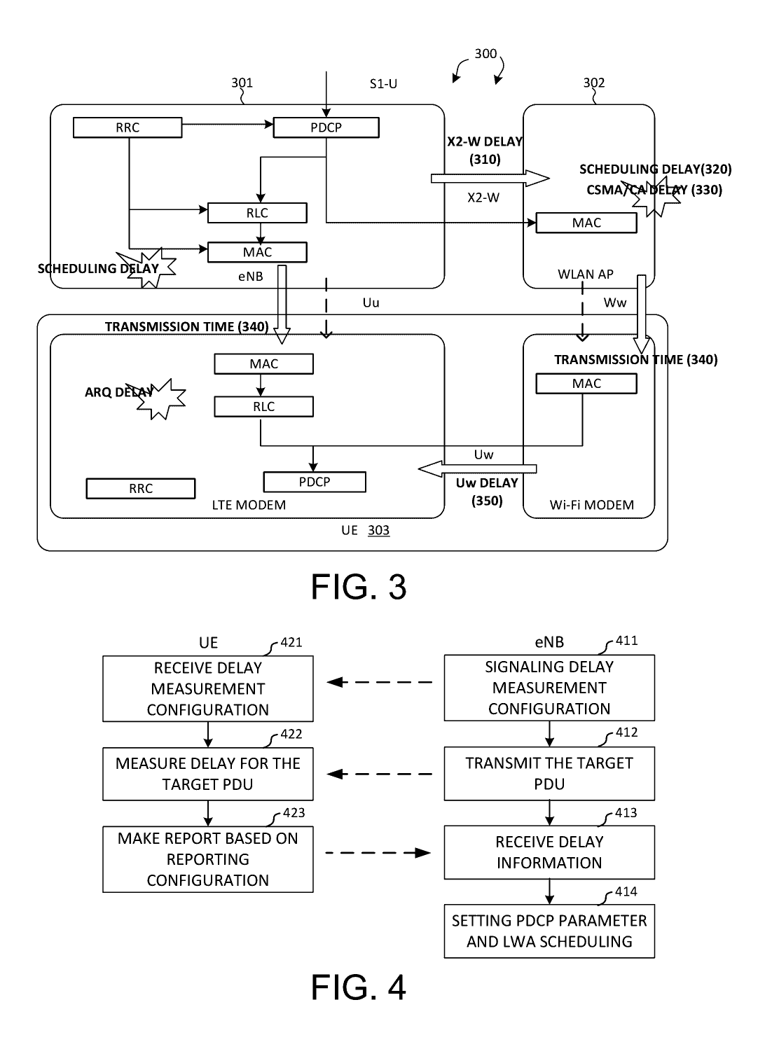

FIG. 3 illustrates an example of the composition of a packet delay via WLAN link in a wireless communication network 300. Wireless communication network 300 comprises a base station eNB 301, a WLAN AP 302, and a UE 303. Before enabling LWA, the eNB will configure LTE channel state information (CSI) report and WLAN reference signal received power (RSRP) measurement to get the channel quality respectively. Sequentially, the achievable PHY rate or MCS could be calculated to support LWA scheduling. However, according to the UPT definition (UPT=packet size/packet delay), make scheduling solely based on the achievable PHY rate does not represent the UPT directly, and the packet delay shall be taken into consideration. Unfortunately, there are several factors to influence packet delay under LWA and no any feedback mechanism was being applied for measuring the value.

As illustrated in FIG. 3, the composition of packet delay via WLAN link contains following. First, user plane backhaul delay (310), which is the PDU routing delay between eNB 301 and AP 302. The eNB needs to probe the corresponding delay when the selecting AP for LWA is different. Even with the same selecting AP, the delay value is variable when the interface between the eNB and the AP is not dedicated. The AP may exchange such information with the eNB when there exists a CP interface. Second, AP scheduling delay (320). This value depends on the adopted scheduling algorithm within WLAN AP 302. It is proportional to AP queue size and EDCA parameter (e.g. TXOP) if RR scheduling is used. Either the AP can broadcast the AP load or exchange the information with the eNB, then the eNB could estimate the AP scheduling delay. Third, CSMA/CA delay (330). This value is relating to the number of competitors in unlicensed spectrum (e.g., neighboring AP, number of STAB and traffic activities). The delay may be changed and non-expectable per PDU translation. Fourth, transmission delay (340). In general, the transmission time=packet size/achievable PHY rate. Fifth, Uw delay (350), which is the ferrying delay from UE Wi-Fi modem to UE LTE modem. It will be a fixed value and be negligible.

There is no method to obtain the end-to-end packet delay from current specification, but that metric is important for deciding the LWA scheduling. This is because the packet delay on LTE and WLAN path are unmatched, and eNB shall take that aspect into scheduling consideration to prevent requiring larger reordering buffer. Furthermore, the setting of PDCP parameter i.e. reordering timer may also require packet delay information and that setting will also have impacts on the UPT. For instance, if the timer set too high then delays add up due to the long expiry for sending the buffered data to upper layer. If too low, then there is higher loss leading to potentially lower TCP throughput caused by contention identification. As a result, new mechanisms to acquire the packet delay are necessary especially when there is no CP/UP interface between eNB and AP.

FIG. 4 illustrates functional blocks of a measurement-based solution of providing packet delay information for LWA. To take packet delay information into consideration, a measurement-based approach between an eNB and a UE can be used. The eNB first configures a delay measurement and signal the configuration to the UE (step 411 and 421), e.g., via Radio Resource Control (RRC) messaging. The eNB then translates target PDUs to the UE over WLAN link (step 412). The UE will measure the round-trip delay with regarding to the target PDU (step 422) and report the measured delay to the eNB based on reporting configuration (steps 423 and 413). It is noted that the measurement could happen periodically or requested by the eNB. With the measurement delay, the eNB combines it with RSRP measurement to decide the PDCP parameter setting and LWA scheduling (step 414).

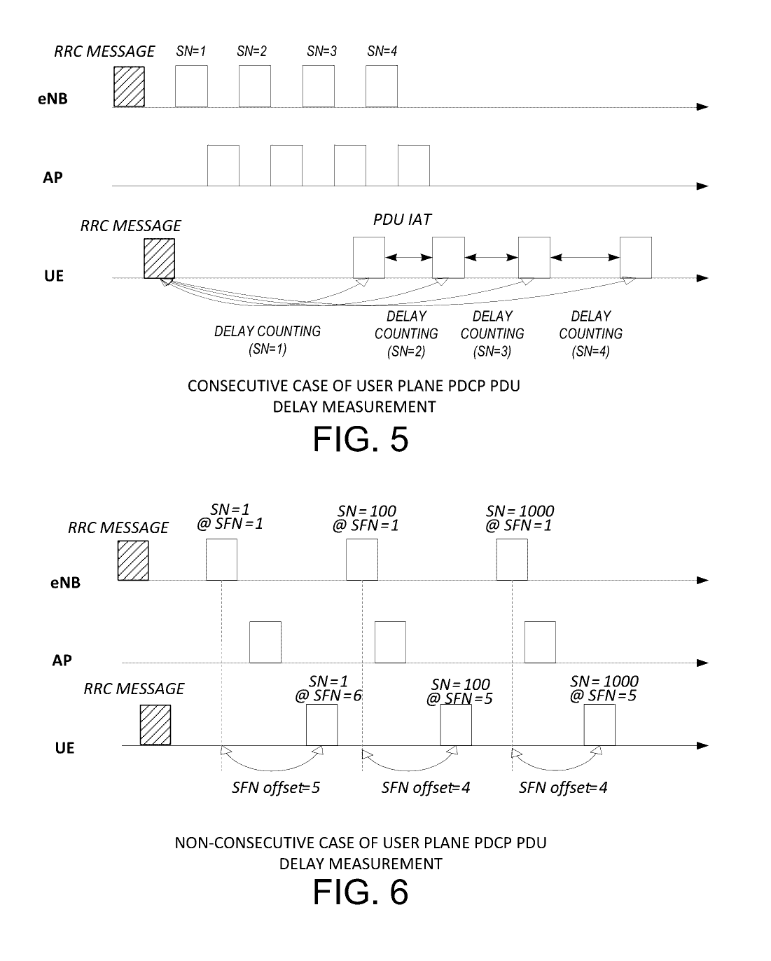

FIG. 5 illustrates a first example of packet delay measurements using user plane PDCP PDU. For user plane PDCP PDU, eNB first configures the delay measurement for UE. The eNB uses RRC signaling to request such measurement with regarding to a set of user plane PDCP PDU. The set of PDCP PDU with specific PDCP sequence number (SN) are translating to WLAN link after the RRC signaling immediately or after a configurable known offset, e.g., 10 ms and the UE starts the delay counting when receiving the configuration. In one example, the RRC message can indicate a set of PDCP SNs and the UE will take average for the measured delay. The set of PDCP SNs can be consecutive or non-consecutive. For consecutive case, the UE will take individual delay counting (use receiving RRC message as a time reference) and the eNB may further specify the filtering rules (e.g., remove the worst and the best values) for taking the average. The eNB may also specify the UE to perform PDU inter-arrival (IAT) counting and feedback the average result.

FIG. 6 illustrates a second example of packet delay measurements using user plane PDCP PDU. Similar to FIG. 5, for user plane PDCP PDU, eNB first configures the delay measurement for UE. The eNB uses RRC signaling to request such measurement with regarding to a set of user plane PDCP PDU. The set of PDCP PDU with specific PDCP SN are translating to WLAN link after the RRC signaling immediately or after a configurable known offset, e.g., 10 ms and the UE starts the delay counting when receiving the configuration. In one example, the RRC message can indicate a set of PDCP SNs and the UE will take average for the measured delay. The set of PDCP SNs can be consecutive or non-consecutive. For non-consecutive PDUs, the eNB may specify the SN respectively and translate the PDU in a dedicated time, e.g., SFN=1. Afterwards, the UE will measure the SFN offset when it receiving the specified PDUs and take average sequentially.

The RRC message can further refer some kind of periodic setup, e.g. 5 consecutive test PDUs for every 100^{th} PDCP PDU. Under this case, the eNB will also configure a timer whereas it will send the 5 consecutive test PDUs until the timer expiring (e.g. eNB shall ensure every 100^{th} PDCP PDU can be delivered before timer expires and the timer will re-start when expires). As a result, the UE does not use receiving RRC message as a time reference to avoid control signaling delay.

Furthermore, the RRC message can configure reporting events for UE. For example, UE may make report only when delay>a predefined threshold; UE may make report only when there is a missing PDU; UE may make report followed by the periodic setup; UE may make report when the number of reordering timer expiring>N in a predefined duration; UE may make report when eNB makes request. The eNB may also use MAC CE to activate/deactivate the delay measurement after configuration or use RRC reconfiguration procedures to cancel the measurement. For moving UE, when associated AP changes, the UE will automatically remove the delay measurement configuration. For delay report, the UE can only indicate delta information (the difference between last report). Upon receiving the delay report, the eNB may utilize that information for LWA scheduling (e.g. change the traffic dispatching ratio) or re-configure the value of reordering timer. It is noted that the drawback of this solution is eNB CP (RRC) and UP (scheduling) need to interact since the RRC message with PDCP SN configuration needs to be sent at the same time as the PDCP PDU is dispatched to the WLAN. Furthermore, it will increase UE complexity since the UE needs to maintain the timer for periodic PDU delay measurement.

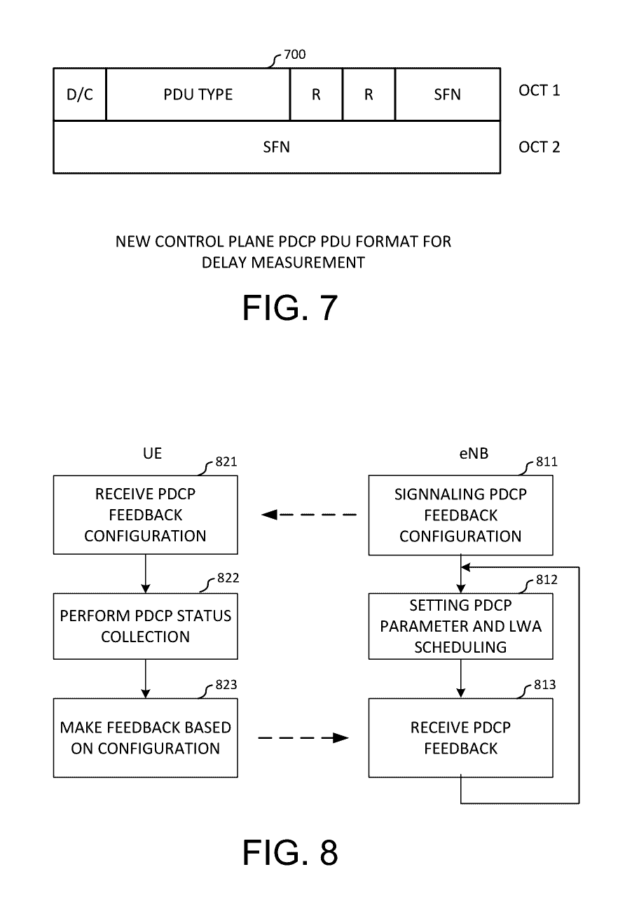

FIG. 7 illustrates an example of packet delay measurements using control plane PDCP PDU. Instead of using SN information, the eNB may use timestamp value appended within a control plane PDCP PDU. When UE receives the control plane PDCP PDU, it will automatically count the delay for the PDU without any pre-RRC configurations. The timestamp value can be a system frame number (SFN) value when the PDU is translating to the WLAN link and the UE will calculate the SFN offset when receiving the PDU and report to the eNB. FIG. 7 is an example of a new control plane PDCP PDU format for delay measurement as depicted by PDU 700.

In one embodiment, UE replies ACK information (one bit) to eNB when successfully receives the control plane PDCP PDU (afterwards, eNB calculate the delay). In another embodiment, UE calculates the SFN offset and report the value to eNB. Note that the ACK bit could be transmitted through MAC CE to reduce overhead. The eNB may send multiple control plane PDCP PDU with respective timestamps, and the UE can calculate the average delay (based on SN offset) and send a report to the eNB. Adding a new PDU type to specify the PDU is used for delay measurement. Another embodiment of this solution is to append a new LWA header with specifying the timestamp information in the control plane PDCP PDU.

The drawbacks of packet delay measurements are the additional CP overhead, and the performance may be influenced by the applying periodicity (e.g. short period is able to reflect delay more accurately). Instead of acquiring PDU delay directly, eNB may decide the PDCP setting/LWA scheduling based on RSRP measurement and delay estimation (e.g. using AP load to estimate the rough packet delay). When LWA is running, UE is requested to provide PDCP layer performance results and eNB may adjust the PDCP setting/LWA setting if needed.

FIG. 8 illustrates functional blocks of an adjustment-based solution of providing PDCP performance information for LWA. As shown in FIG. 8, the eNB first configures for PDCP feedback and signal the PDCP feedback configuration to the UE (steps 811 and 821), e.g., via RRC signaling message. The eNB also decides the initial PDCP setting and LWA scheduling (step 812). The UE will perform PDCP status collection (step 822) and report the PDCP status feedback to the eNB based on configuration (step 823). The PDCP status comprises either PDCP error events or PDCP PDU statistics. With the PDCP status feedback received in step 813, the eNB can adjust the PDCP parameter setting and LWA scheduling (step 812).

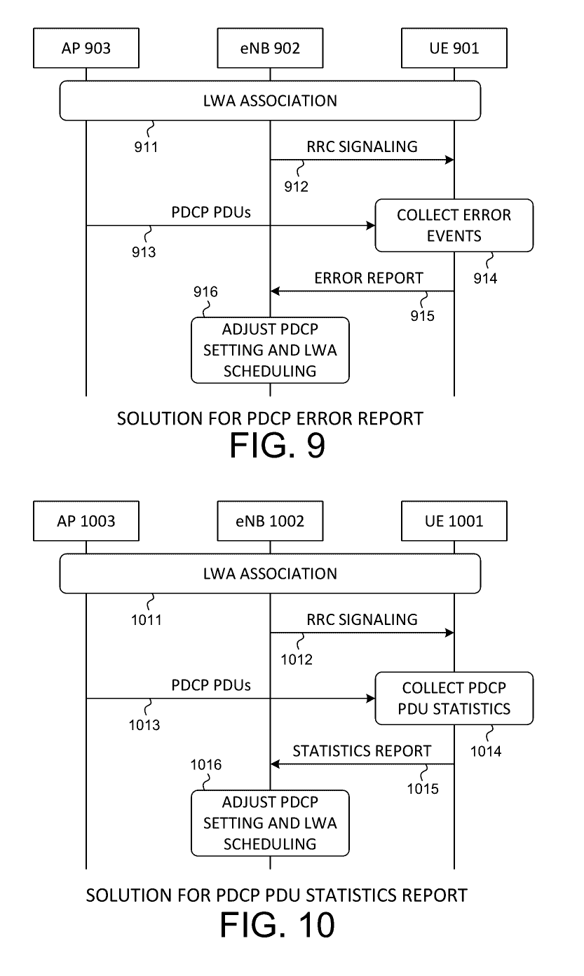

FIG. 9 illustrates one embodiment of PDCP error report for adjusting PDCP parameter setting and LWA scheduling. In a wireless network, UE 901, LTE base station eNB 902, and Wi-Fi access point AP 903 perform LWA association in step 911. Specifically, eNB 902 provides LWA configuration with cooperating WLANs to UE 901. UE 901 establishes one or more data radio bearer (DRBs) with eNB 902 for data transmission over the cellular interface. In addition, UE 901 also connects to AP 903 for WLAN access. Instead of using measurement, in step 912, eNB 902 configures a PDCP error reporting mechanism to UE 901 via RRC signaling. In step 913, UE receives PDCP PDUs from AP 903 via WLAN link. In step 914, UE 901 performs PDCP error events collection. In step 915, UE 901 indicates the error events when the specified PDCP error event occurred. For example, when a reordering timer expires, there are larger problems in the network than flow control/scheduling can solve. Occasional expiry of the timer may not require any action but it happens frequently, then it is helpful to indicate the case to the network. Therefore, the eNB may request UE to indicate the event when reordering timer>N expires in T seconds. After receiving the indication, the eNB was informed that frequent expiry of reordering timer and may try to resolve the problem by changing the tunnel configuration between eNB and WLAN node or directly releasing the splitting bearer.

The possible PDCP error event includes: consecutive expiry of reordering timer (e.g. 3 consecutive expires); excessive expires in a time interval; consecutive time without receiving any data from WLAN (e.g. 200 ms); few packets from WLAN in a time interval (e.g. less 10 packets in 2 s); the splitting bearer does not satisfy the rate requirement (e.g. measured throughput falls below the required rate). It is noted that different DRB may have respective error report configurations and the UE shall indicate the DRB ID when reporting. A prohibit timer may be also introduced to prevent excessive reporting. Based on the error report, eNB 902 can adjust the LWA and flow control accordingly (step 916).

FIG. 10 illustrates one embodiment of PDCP PDU statistics report for adjusting PDCP parameter setting and LWA scheduling. FIG. 10 is similar to FIG. 9.

However, rather than indicating the error case in step 915, UE 1001 may further be configured in step 1012 to report complete PDCP PDU statistics in step 1015. With such information, eNB 1002 is able to identify the problem to adjust the scheduling or change the PDCP setting appropriately in step 1016. The content of PDCP PDU statistics may comprise: a typical C-plane PDCP status report with indicating FMS/bitmap information to let eNB know which SN PDCP was lost; a new C-plane PDCP status report with compacted information (e.g. only indicating the FMS); a new C-plane PDCP statistics report with indicating the number of receiving packets from eNB and WLAN in a time interval separately; a new C-plane PDCP statistics report with indicating the average packet inter-arrival time from eNB and WLAN separately; a new C-plane PDCP statistics report with indicating the UE's preferred reordering timer and scheduling criteria e.g. the bound of traffic amount translating to WLAN link.

The eNB could configure the content of reporting and its periodicity by RRC signaling. It is noted that the periodicity of PDCP PDU statistics reports needs to be managed carefully to ensure 1) uplink overhead of carrying these reports is not excessive, and 2) avoiding unnecessary re-transmissions (e.g. too-early report). Two reporting mechanisms can be used. First, two cycles for the periodic reporting: using short cycle initially, and switch to long cycle when a configured timer expires without any losing PDU, otherwise using short cycle. Second, s prohibit timer: when the timer is not running, the UE is allowed to make reporting when there is a losing PDU. Otherwise, the reporting is prohibited and the timer will re-start after the successful reporting.

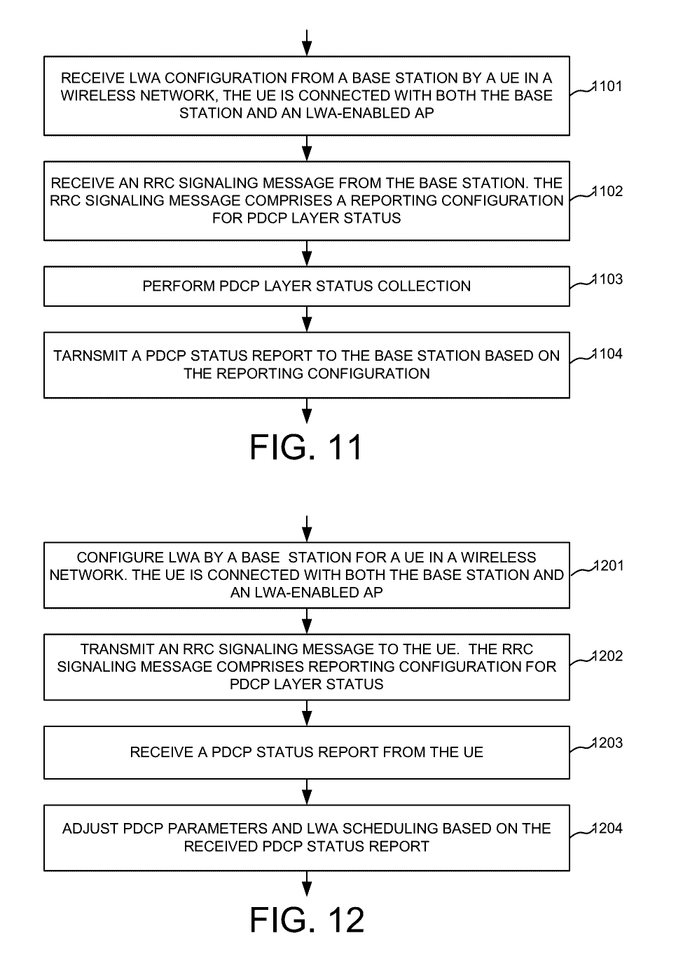

FIG. 11 is a flow chart of a method of providing PDCP error status/PDCP PDU statistics from UE perspective for adjusting PDCP parameter setting and LWA scheduling in accordance with one novel aspect. In step 1101, a UE receives an LTE WLAN aggregation (LWA) configuration from a base station in a wireless network. The UE is connected to both the base station and an LWA-enabled access point (AP). In step 1102, the UE receives a radio resource control (RRC) signaling message from the base station. The RRC signaling message comprises reporting configuration for packet data convergence protocol (PDCP) status. In step 1103, the UE performs PDCP layer status collection. In step 1104, the UE transmits a PDCP status report to the base station based on the reporting configuration. In one embodiment, the PDCP status comprises PDCP error events. In another embodiment, the PDCP status comprises PDCP PDU statistics.

FIG. 12 is a flow chart of a method of providing PDCP error status/PDCP PDU statistics for adjusting PDCP parameter setting and LWA scheduling from eNB perspective in accordance with one novel aspect. In step 1201, a base station configures LTE WLAN aggregation (LWA) for a UE in a wireless network. The UE is connected to both the base station and an LWA-enabled access point (AP). In step 1202, the base station transmits a radio resource control (RRC) signaling message to the UE. The RRC signaling message comprises reporting configuration for PDCP layer status. In step 1203, the base station receives a PDCP status report from the UE. In step 1204, the base station adjusts PDCP parameters and LWA scheduling based on the received PDCP status report. In one embodiment, the PDCP status comprises PDCP error events. In another embodiment, the PDCP status comprises PDCP PDU statistics.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving an LTE-WLAN aggregation (LWA) configuration from a base station by a user equipment (UE) in a wireless network, wherein the UE is connected with both the base station and an LWA-enabled access point (AP);
receiving a radio resource control (RRC) signaling message from the base station, wherein the RRC signaling message comprises a reporting configuration for packet data convergence protocol (PDCP) status;
performing PDCP status collection; and
transmitting a PDCP status report to the base station based on the reporting configuration.

2. The method of claim 1, wherein the PDCP status comprises configured PDCP error events.

3. The method of claim 2, wherein the configured PDCP error events comprises at least one of consecutive expiry of a PDCP reordering timer, PDCP reordering timer expiry more than a threshold during a predefined time interval, packets received from WLAN less than a threshold in a predefined time interval, and a split bearer does not satisfy a rate requirement.

4. The method of claim 2, wherein the PDCP status report is triggered by the PDCP error events configured per data radio bearer (DRB) established between the UE and the base station.

5. The method of claim 1, wherein the PDCP status comprises PDCP protocol data unit (PDU) statistics.

6. The method of claim 5, wherein the PDCP PDU statistics indicates at least one of serial number (SN) of lost PDCP PDU, FMS (first missing PDCP SN) information, number of packets received from LTE and from WLAN separately, average packet-inter-arrival time from LTE and from WLAN separately, and UE preferred PDCP reordering timer and scheduling criteria.

7. The method of claim 5, wherein the PDCP PDU statistics reporting is periodically configured, and wherein a shorter reporting periodicity or a longer reporting periodicity is applied based on PDCP PDU statistics.

8. A user equipment (UE), comprising:
an LTE-WLAN aggregation (LWA) configurator that configures from a base station by a user equipment (UE) in a wireless network, wherein the UE is connected with both the base station and an LWA-enabled access point (AP);
a receiver that receives a radio resource control (RRC) signaling message from the base station, wherein the RRC signaling message comprises a reporting configuration for packet data convergence protocol (PDCP) status;
a collector that performs PDCP status collection; and
a transmitter that transmits a PDCP status report to the base station based on the reporting configuration.

9. The UE of claim 8, wherein the PDCP status comprises configured PDCP error events.

10. The UE of claim 9, wherein the configured PDCP error events comprises at least one of consecutive expiry of a PDCP reordering timer, PDCP reordering timer expiry more than a threshold during a predefined time interval, packets received from WLAN less than a threshold in a predefined time interval, and a split bearer does not satisfy a rate requirement.

11. The UE of claim 9, wherein the PDCP status report is triggered by the PDCP error events configured per data radio bearer (DRB) established between the UE and the base station.

12. The UE of claim 8, wherein the PDCP status comprises PDCP protocol data unit (PDU) statistics.

13. The UE of claim 12, wherein the PDCP PDU statistics indicates at least one of serial number (SN) of lost PDCP PDU, FMS (first missing PDCP SN) information, number of packets received from LTE and from WLAN separately, average packet-inter-arrival time from LTE and from WLAN separately, and UE preferred PDCP reordering timer and scheduling criteria.

14. The UE of claim 12, wherein the PDCP PDU statistics reporting is periodically configured, and wherein a shorter reporting periodicity or a longer reporting periodicity is applied based on PDCP PDU statistics.

15. A method comprising:
configuring LTE-WLAN aggregation (LWA) by a base station for a user equipment (UE) in a wireless network, wherein the UE is connected with both the base station and an LWA-enabled access point (AP);
transmitting a radio resource control (RRC) signaling message to the UE, wherein the RRC signaling message comprises a reporting configuration for packet data convergence protocol (PDCP) status;
receiving a PDCP status report from the UE; and
adjusting PDCP parameters and LWA scheduling based on the received PDCP status report.

16. The method of claim 15, wherein the PDCP status comprises configured PDCP error events.

17. The method of claim 16, wherein the configured PDCP error events comprises at least one of consecutive expiry of a PDCP reordering timer, PDCP reordering timer expiry more than a threshold during a predefined time interval, packets received from WLAN less than a threshold in a predefined time interval, and a split bearer does not satisfy a rate requirement.

18. The method of claim 16, wherein the PDCP status report is triggered by the PDCP error events configured per data radio bearer (DRB) established between the UE and the base station.

19. The method of claim 15, wherein the PDCP status comprises PDCP protocol data unit (PDU) statistics.

20. The method of claim 19, wherein the PDCP PDU statistics indicates at least one of serial number (SN) of lost PDCP PDU, FMS (first missing PDCP SN) information, number of packets received from LTE and from WLAN separately, average packet-inter-arrival time from LTE and from WLAN separately, and UE preferred PDCP reordering timer and scheduling criteria.

21. The method of claim 19, wherein the PDCP PDU statistics reporting is periodically configured, and wherein a shorter reporting periodicity or a longer reporting periodicity is applied based on PDCP PDU statistics.
